(19) United States
(12) Patent Application Publication
(10) Pub. No.: US 2012/0318085 A1
(43) Pub. Date: Dec. 20, 2012

(54) RACK BAR SUPPORTING DEVICE FOR VEHICLE STEERING APPARATUS

(75) Inventor: Ki Che PARK, Wonju-si (KR)

(73) Assignee: MANDO CORPORATION

(21) Appl. No.: 13/524,426

(22) Filed: Jun. 15, 2012

(30) Foreign Application Priority Data
Jun. 17, 2011 (KR) 10-2011-0058830

(51) Int. Cl. F16H 55/28

(52) U.S. Cl. 74/409

(57) ABSTRACT

The present invention relates to a rack bar supporting device for a vehicle steering apparatus. According to the present invention, it is possible to compensate for a clearance even when the yoke is worn after the durability of a vehicle is lost to a certain degree. Consequently, it is possible to prevent a noise caused by an impact reversely input from an uneven road surface due to the increase of the clearance and to provide a driver with a pleasant steering feeling. In addition, since it is possible to assemble a rack bar supporting device, which includes several components, to a gear box, in a state where the components are integrally coupled to each other, it is possible to reduce difficulty in assembling and the length of time for assembling, and to prevent the loss of the components.

### BACKGROUND OF THE INVENTION

1. Field of the invention

The present invention relates to a rack bar supporting device for a vehicle steering device. More particularly, the present invention relates to a rack bar supporting device for a rack-and-pinion type steering apparatus of a vehicle, in which the rack bar supporting device is configured to be capable of compensating for a change of a clearance due to the wear of a support yoke of the vehicle even when the support yoke is worn after the vehicle has lost the driving durability thereof to a certain degree, so as to prevent a noise from being produced by an impact reversely input from an irregular road surface or the like due to the increase of the clearance, and to provide a pleasant steering feeling to a driver, and the rack bar supporting device is configured to be capable of being assembled to a gear box in a state where a plurality of components thereof are integrally assembled to each other, so as to reduce difficulty in assembly and the length of time for assembly, and to prevent the components from being lost during assembly.

2. Description of the Prior Art

As generally known in the art, a steering apparatus of a vehicle means an apparatus that allows a driver to change a driving direction of the vehicle by his/her will. The steering apparatus helps the driver to optionally change the center of rotation, about which the vehicle's front wheels are turned, so as to make the vehicle move in a direction desired by the driver.

FIG. 1 is a schematic view of a conventional rack-and-pinion type steering apparatus for a vehicle, and FIG. 2 is a cross-sectional view of a conventional rack bar supporting device.

As illustrated in the drawings, a conventional rack-and-pinion type steering apparatus includes: a steering wheel 100 arranged at a driver's seat side; a steering shaft 105 connected to the steering wheel 100; a steering column 103 configured to allow the steering shaft 100 to be fixed to a vehicle body; a gear box 130 provided with a rack gear 110 and a pinion gear 120 to convert a turning force input from the steering shaft 105 to a rectilinear movement; a rack bar 140 provided with an inner ball joint 135 at each end thereof; and a tie rod 150 integrally formed with a ball of the inner ball joint 135.

The tie rod 150 is connected with an outer ball joint 155 and transfers a force to a knuckle 159 to steer tires 158.

In addition, the conventional rack bar supporting device includes a pinion gear 120, a rack bar 140, a support yoke 260, a spring 263, and a yoke plug 265. As described above, the rack-and-pinion type gear box 130 is adapted to convert a turning force input from a steering shaft (not shown) to a rectilinear movement.

The rack bar 140 is engaged with the pinion gear 120 to convert a turning movement into a rectilinear movement, in which a device for supporting the rack bar 140 in relation to the pinion gear 120 side is provided behind the rack bar 140 so as to facilitate the engagement between the rack bar 140 and the pinion gear 120.

The device for supporting the rack bar 140 includes a support yoke 260, a spring 263, and a yoke plug 265, in which the support yoke 260 is positioned opposite to the rear side of the rack bar 140, on which the rack gear 110 is formed, and is inserted into a cylinder 250 of the gear box 130 to be movable forward and backward perpendicularly to the rack bar 140.

The support yoke 260 is formed in a cylindrical shape so that it can be slid forward and backward, and on the front side thereof where the support yoke 260 is in contact with the rack bar 140, the support yoke 260 is formed with a groove of a semicircular cross-section, so that the front side of the support yoke 260 can be in close contact with the rear side of the rack bar 140.

In addition, in order to assure that the rack bar 140 and the pinion gear 120 can be in close contact with each other to efficiently transfer a force, the spring 263 is arranged behind the support yoke 260 to push the support yoke 260 with a predetermined pressure so as to compensate a clearance produced between the rack bar 140 and the pinion gear 120.

The support yoke 260 is caused to be frictionally slid against the rear side of the rack bar 140. In order to prevent the rack bar 140 from being worn or producing a noise due to friction, the support yoke 260 is typically formed of a plastic material softer than the rack bar 140.

The spring 263 received in the spring groove 220 serves to apply pressure so that the support yoke 260 comes into close contact with the rack bar 140. Typically, a coil spring is employed as the spring 263, and the yoke 265 is positioned behind the spring 263 to support the spring 263.

The yoke 265 supports the spring 263, so that the spring 263 can apply pressure to the support yoke 260. Since the yoke plug 265 is typically formed with peaks and valleys of threads so that the yoke plug 265 can be fixedly engaged with the gear box 130 and a lock nut 240, which are formed with peaks and valleys of threads corresponding to those of the yoke plug 265.

However, such a conventional rack bar supporting device has problems in that since the support yoke, the spring, the yoke plug, etc. should be individually assembled one by one, the length of time for assembly is increased, the assembly process is difficult, and the components may be lost in the assembly field.

In addition, when the support yoke has lost durability to a certain degree, a clearance between the support yoke and the rack bar is increased to such an extent that the support yoke cannot properly support the rack bar, and due to the increase of the clearance, a rattle noise may be produced from the support yoke and the yoke plug.

Moreover, when the clearance between the support yoke and the rack bar is increased, a repairman should completely disassemble the yoke plug and the support yoke and tighten the yoke plug by the increased extent of the clearance, which may increase difficulty in after-sales services.

### SUMMARY OF THE INVENTION

Accordingly, the present invention has been made to solve the above-mentioned problems occurring in the prior art, and an aspect of the present invention is to provide a rack bar supporting device for a rack-and-pinion type steering apparatus of a vehicle, in which the rack bar supporting device is configured to be capable of compensating for a change of a clearance due to the wear of a support yoke of the vehicle even when the support yoke is worn after the vehicle has lost the driving durability thereof to a certain degree, so as to prevent a noise from being produced by an impact reversely input from an irregular road surface or the like due to the increase of the clearance, and to provide a pleasant steering feeling to a driver, and the rack bar supporting device is configured to be capable of being assembled to a gear box in a state where a plurality of components thereof are integrally assembled to each other, so as to reduce difficulty in assembly and the length of time for assembly, and to prevent the components from being lost during assembly.

In accordance with an aspect of the present invention, there is provided a rack bar supporting device for a vehicle steering apparatus, including: a support yoke configured to support a rack bar; a support disk, the front side of which supports the support yoke, and the rear side of which is provided with a step part positioned at a diametrically outer part and formed to be axially stepped; a yoke plug configured to be screw-coupled with a gear box, and provided with a supporting part formed to axially extend at a position corresponding to the step part; and a torsion spring interposed between the support disk and the yoke plug.

In accordance with another aspect of the present invention, there is provided a rack bar supporting device for a vehicle steering apparatus, including: a support yoke configured to support a rack bar; a support disk, the front side of which supports the support yoke, and the rear side of which is provided with a supporting part positioned at a diametrically outer part and formed to axially extend; a yoke plug configured to be screw-coupled with a gear box, and provided with a supporting part formed to be axially stepped at a position corresponding to the supporting part; and a torsion spring interposed between the support disk and the yoke plug.

According to the present invention, it is possible to compensate for a clearance even when the yoke is worn after the durability of a vehicle is lost to a certain degree. Consequently, it is possible to prevent a noise caused by an impact reversely input from an uneven road surface due to the increase of the clearance and to provide a driver with a pleasant steering feeling. In addition, since it is possible to assemble a rack bar supporting device, which includes several components, to a gear box, in a state where the components are integrally coupled to each other, it is possible to reduce difficulty in assembling and the length of time for assembling, and to prevent the loss of the components.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view of a conventional rack-and-pinion type steering apparatus for a vehicle;

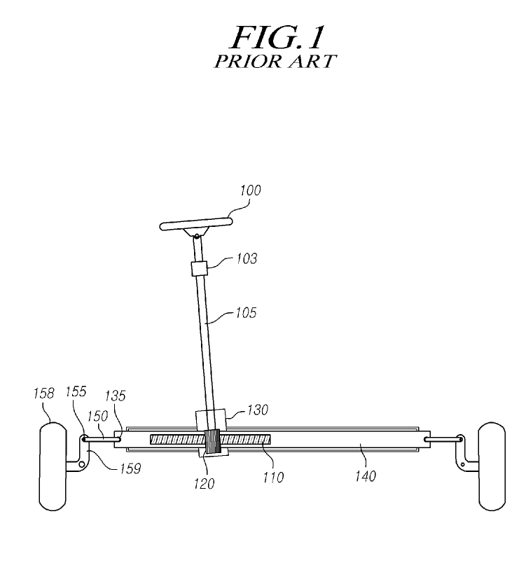

FIG. 2 is a cross-sectional view of a conventional rack bar supporting device;

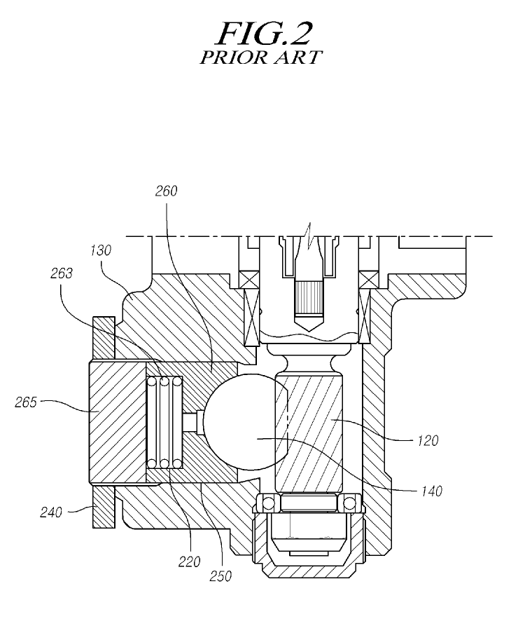

FIG. 3 is an exploded perspective view illustrating a rack bar supporting device for a vehicle in accordance with a first exemplary embodiment of the present invention;

FIG. 4 is an exploded perspective view illustrating a part of the rack bar supporting device in accordance with the first exemplary embodiment of the present invention;

FIG. 5 is a perspective view illustrating a part of the rack bar supporting device for a vehicle in accordance with the first exemplary embodiment of the present invention;

FIG. 6 is a cross-sectional view illustrating the rack bar supporting device for a vehicle in accordance with the first exemplary embodiment of the present invention; and

FIG. 7 is a cross-sectional view illustrating a rack bar supporting device for a vehicle in accordance with a second exemplary embodiment of the present invention.

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

In the detailed description of the present invention, descriptions will be made assuming that the rack bar side which is positioned in front of the support yoke is the front, and the opposite side is the rear unless specifically defined, for the convenience of description.

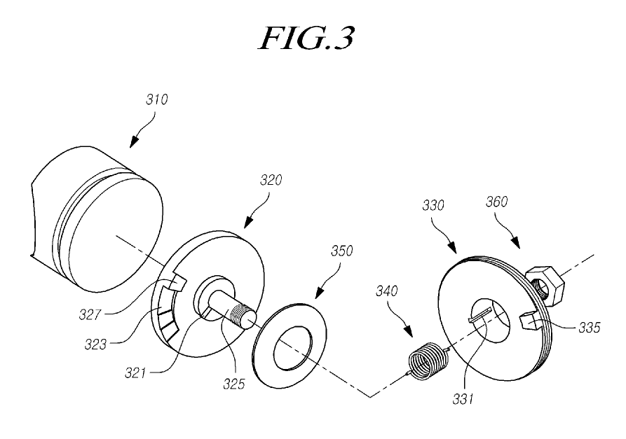

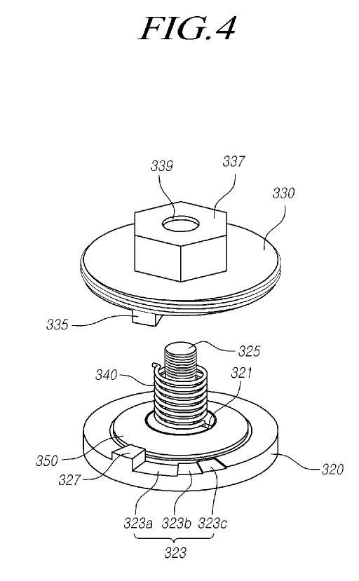

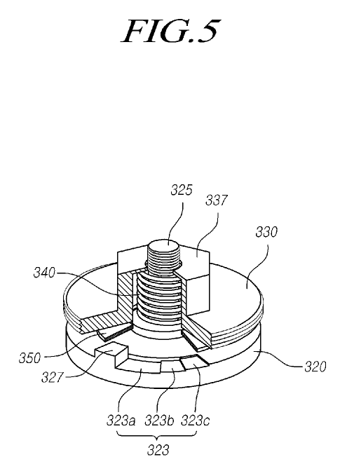

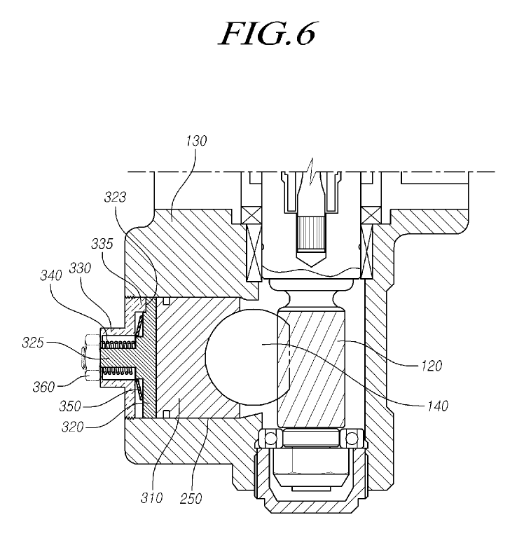

FIG. 3 is an exploded perspective view illustrating a rack bar supporting device for a vehicle in accordance with a first exemplary embodiment of the present invention, FIG. 4 is an exploded perspective view illustrating a part of the rack bar supporting device in accordance with the first exemplary embodiment of the present invention, FIG. 5 is a perspective view illustrating a part of the rack bar supporting device for a vehicle in accordance with the first exemplary embodiment of the present invention, and FIG. 6 is a cross-sectional view illustrating the rack bar supporting device for a vehicle in accordance with the first exemplary embodiment of the present invention.

As illustrated in these drawings, the rack bar supporting device for a vehicle includes: a support yoke 310 configured to support a rack bar 140 against a pinion gear 120, and to be coupled to a gear box 130; a support disk 320, the front side of which supports the support yoke 310, and the rear side of which is formed with a step part 323 axially stepped at a diametrically outer part; a yoke plug 330 screw-coupled with the gear box 130 along the outer circumferential surface thereof and configured to be engaged with the support disk 320 through a torsion spring 340 to provide rotational force to the support disk 320, the yoke plug 330 being provided with a supporting part 335 formed to extend axially at a position corresponding to the step part 323 to make the support disk 320 move toward the support yoke 310 when the support disk 320 is rotated; and the torsion spring 340 interposed between the support disk 320 and the yoke plug 330.

The support yoke 310 is configured to be in close contact with the rear side of the rack bar 140 which is meshed with a pinion gear 120 to support the rack bar 140 forwardly so as to keep the rack gear and the pinion gear 120 properly meshed with each other.

In order to keep the rack bar 140 and the pinion gear 120 closely contacted with each other to efficiently transmit force, such a support yoke 310 is configured to be slid toward the support yoke 310 while being rotated by the elastic force produced by the torsion spring 340 abutted against the yoke plug 330, and to push the support yoke 310 forward, so that a predetermined clearance between the support yoke 310 and 140 can be maintained.

That is, the support yoke 310 is inserted into a cylinder 250 of the gear box 130, so that the front side of the support yoke 310 comes into close contact with the rear side of the rack bar 140, and the support disk 320 supported by the yoke plug 330 is configured to push the support yoke 310 forward while conducting rotational and sliding movements on the rear side of the support yoke 310.

A concave arc-shaped support surface for supporting the rack bar 140 is formed on the front side of the support yoke 310, in which a yoke sheet (not shown) may be attached to the support surface to reduce frictional force with the rack bar 140 and the wear and tear when the rack bar 140 is slid.

The support disk 320 is coupled to the rear side of the support yoke 310 while being supported by the yoke plug 330, in which the front side of the support disk 320 supports the support yoke 310 against the rack bar 140, and the rear side of the support disk 320 is provided with a step part 323 supported by the supporting part 335 of the yoke plug 330.

Two or more supporting parts 335 may be provided. In such a case, the supporting parts 335 are formed to be circumferentially spaced from each other, and the same number of step parts 323 may also be formed to correspond in position with the supporting parts 335.

As being formed at a diametrically outer position on the rear side of the support disk 320 to be axially stepped, the step part 323 is adapted to be supported by the supporting part 335 of the yoke plug 330 to be described later, and to be axially slidable by a difference in height in the step part 323 when the support disk 320 is rotated.

In addition, The yoke plug 330 is formed with threads on the outer circumference thereof to be screw-coupled to the cylinder 250 of the gear box 130. In addition, the yoke plug 330 is coupled with the support disk 320 through the torsion spring 340 so that rotation force can be produced on the support disk 320.

The torsion spring 340 is adapted to produce rotational force on the support disk 320, in which one end of the torsion spring 340 is coupled to a hook part 321 of the support disk 320, and the other end is coupled to a hook part 331 of the yoke plug 330.

In addition, the yoke plug 330 is provided with a supporting part 335 extending toward the step part 323 of the support disk 320 at a position corresponding to the step part 323, so that the yoke plug 330 can be moved toward the support yoke 310 when the support disk 320 is rotated by the torsion spring 340.

Accordingly, when the yoke plug 330 is fixedly coupled to the gear box 130 by pushing the support disk 320 toward the support yoke 310, and the support disk 320 receives rotational force from the torsion spring 340, an axial force biased toward the support yoke 310 by a difference in height of the step part 323 is produced while the step part 323 is being supported and rotated by the supporting part 335.

When no wear exists in the support yoke 310 at the initial stage, the initial axial force maintains the force for supporting the rack bar 140 of the support yoke 310 constantly, thereby preventing a noise from being produced by an impact reversely input through the rack bar 140 from an uneven road surface.

When a certain length of time for durability has passed such that the worn amount of the support yoke 310 is increased, thereby producing a clearance, and the clearance exceeds the difference in height of the step part 323, the support disk 320 is additionally rotated by the elastic force of the torsion spring 340, and further moved toward the support yoke 310 by the difference in height of the step part 323.

In addition, an elastic member 350 may be interposed between the support disk 320 and the yoke plug 330 to provide elastic force for biasing the support disk 320 and the yoke 330 away from each other. A compression coil spring or a leaf spring as illustrated in FIGS. 3 to 7 may be used as the elastic member 350. However, the present invention is not necessarily limited to these, and a cylindrical elastic member 350 formed from an elastic material, such as rubber, silicon and urethane.

Such an elastic member 350 produces a supporting force for additionally supporting the support yoke 310 against the rack bar 140 when the worn amount of the support yoke 310, i.e. the clearance between the rack bar 140 and the support yoke 310 does not exceed the difference in height of the step part 323, thereby preventing noise.

Meanwhile, a guide part 325 is formed to extend from the center on the rear side of the support disk 320, i.e. the side of the support disk 320 oriented toward the yoke plug 330 among both sides of the support disk 320, and a guide hole 339 is formed through the center of the yoke plug 330, so that the guide part 325 extends through the guide hole 339 and is supported when slid. As a result, when the support disk 320 is slid while being rotated by the torsion spring 340, the axial movement of the support disk 320 is adapted to be supported.

In addition, for the convenience of assembling the support disk 320 and the yoke plug 330 to the gear box 130 in a state where the support disk 320 and the yoke plug 330 are integrally coupled to each other, the guide part 325 may be formed with threads on the outer circumference thereof, and a provisional assembling nut 360 may be coupled to the guide part 325 in the outside of the rear side of the yoke plug 330 in a state where the guide part 325 extends through the guide hole 339.

That is, for the convenience of assembling, it is possible to fasten the provisional assembling nut 360 to the guide part 325 while applying torsion to the torsion spring 340 in the state where the guide part 325 extends through the guide hole 339 of the yoke plug 330, and to couple the provisional assembly formed thereby to the cylinder 250 of the gear box 130.

After being integrally coupled by the provisional assembling nut 360 in this manner, the yoke plug 330 is screw-coupled to the cylinder 250 of the gear box 130 to fix the position of the yoke plug 330, and then the provisional assembling nut 360 is released and removed. As such, the support disk 320 will support the support yoke 310 while performing rotational and sliding movements between the support yoke 310 and the yoke plug 330 by the rotational elastic force of the torsion spring 340.

If the support disk 320 and the yoke plug 330 integrally coupled to each other in this manner are coupled to the cylinder 250 of the gear box 130, it is possible to solve the problems, such as increased length of time for assembling, difficult in assembling, and loss of components, which may occur when these components are assembled one by one.

In addition, a stopper 327 may be formed at a circumferential end of the step part 323 to be supported by the supporting part 335 of the yoke plug 330 and to limit the rotational movement of the support disk 320. Then, it is possible to set a position for provisionally assembling the support disk 320 and the yoke plug 330 while applying torsion to the torsion spring 340 at the time of provisionally assembling the support disk 320 and the yoke plug 330 by the provisional assembling nut 360.

After a certain length of time has passed to such an extent that the durability of the rack bar supporting device is lost to a certain extent, a clearance is increased between the support yoke 310 and the rack bar 140 due to the wear therebetween. If the clearance is increased, the supporting force of the rack bar 140 may be reduced, and a rattle noise may be produced, which will cause a steering feeling of a driver to be deteriorated.

Therefore, it is possible to form two or more step parts 323a, 323b and 323c for the step part 323, which are stepped axially so as to compensate by degrees for the increased clearance between the rack bar 140 and the support yoke 310 when the durability is lost to a certain degree to such an extent that the clearance is increased due to wear. If two or more step parts 323a, 323b and 323c for the step part 323 are formed in this manner, the individual step parts 323a, 323b and 323c are continuously formed in the circumferential direction of the support disk 320.

That is, it is possible to form two or more step parts 323a, 323b and 323c continuously in the circumferential direction such than the axial width of each of the step parts, that is the thickness between the step part-formed side and the opposite side is increased step by step in the circumferential direction. Then, as the worn amount of the support yoke 310 is increased, the distance between the support disk 320 and the yoke plug 330 is increased step by step.

The difference in heights of the individual step parts continuously formed in this manner are determined to be increased by a constant value in the range of 0.07 mm to 0.13 mm, so that the axial width of each of the steps is axially increased. At the time of initial assembling, the supporting part 335 is supported by and coupled to the first step part 323a which has the smallest axial width. Thereafter, when the worn amount of the support yoke 310 arrives at the difference in height of the first step part 323a, the support disk 320 is rotated by the torsion spring 340. Then, the second step part 323b is coupled to the supporting part 335b, and slid toward the support yoke 310 by the difference in height of the second step part 323b to compensate for the clearance, in which the second step part 323b neighbors the first step part 323a and is stepped in relation to the first step part 323a, i.e. has an axial width larger than that of the first step part 323a by the difference in height in the range of 0.07 mm to 0.13 mm. Thereafter, when the worn amount of the support yoke 310 arrives again at the difference in height of the second step part 323b, the third step part 323c, which neighbors the second step part 323b, is coupled to the supporting part 335, and slid toward the support yoke 310 by the difference in height of the third step part 323c to compensate for the clearance.

A tool fastening part 337 in a shape of a bolt head or a nut is formed at the rear part of the yoke plug 330 such that a tool is fitted on and fastened to the tool fastening part 337, which makes it easy to assemble the yoke plug 330 to the gear box 130.

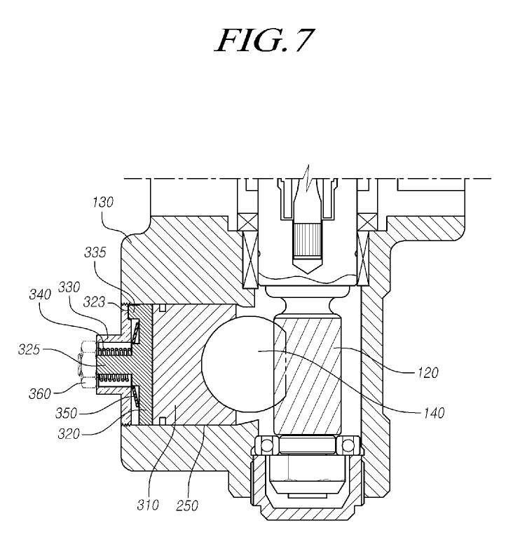

FIG. 7 is a cross-sectional view illustrating a rack bar supporting device for a vehicle in accordance with the second exemplary embodiment of the present invention.

The rack bar supporting device for a vehicle in accordance with the second exemplary embodiment of the present invention includes: a support yoke 310 configured to support a rack bar 140 against a pinion gear 120, and to be coupled to a gear box 130; a support disk 320, the front side of which supports the support yoke 310, and the rear side of which is provided with a supporting part 335 formed to axially extend at a diametrically outer part; a yoke plug 330 configured to be screw-coupled with the gear box 130 along the outer circumferential surface thereof and to be engaged with the support disk 320 through a torsion spring 340 to provide rotational force to the support disk 320, the yoke plug 330 being provided with a step part 323 formed to be stepped axially at a position corresponding to the supporting part 335 to make the support disk 320 move toward the support yoke 310 when the support disk 320 is rotated; and the torsion spring 340 interposed between the support disk 320 and the yoke plug 330.

The second exemplary embodiment of the present invention is different from the first exemplary embodiment in terms of the supporting part 335 and the step part 323 in that the supporting part 335 is formed on the support disk 320, and the step part 323 corresponding to the supporting part 335 is formed on the yoke plug 330. Hereinbelow, the second exemplary embodiment will be described mainly with the differences between the first and second exemplary embodiments.

The support disk 320 is supported by the yoke plug 330 and coupled to the rear side of the support yoke 310. The front side of the support disk 320 supports the support yoke 310 against the rack bar 140, and the rear side is provided with a supporting part 335 formed to extend toward the yoke plug 330 instead of a step part 323 unlike the first exemplary embodiment. The yoke plug 330 is also provided with the step part 323 at the position corresponding to the supporting part 335 of the support disk 320, so that the support disk 320 can be moved toward the support yoke 310 while being rotated by the torsion spring 340, unlike the first exemplary embodiment.

The supporting part 335 is formed at a diametrically outer position on the rear side of the support disk 320, and the step part 323 is formed on the front side of the yoke plug 330 to be axially stepped.

Therefore, the yoke plug 330 is configured to be fixedly coupled to the gear box 130 while pushing the support disk 320 toward the support yoke 310, and the support disk 320 is configured such that upon receiving rotation force from the torsion spring 340, the support disk 320 compensates for the clearance between the support yoke 310 and the rack bar 140 by an axial force biased to move the support disk 320 toward the support yoke 310 by the difference in height of the step part 323 as the supporting part 335 is rotated while being supported by the step part 323.

Except the positional differences that the supporting part 335 is formed on the support disk 320, and the step part 323 is formed on the yoke plug 330, the second exemplary embodiment is equal to the first exemplary embodiment. Therefore, the further detailed description of the second exemplary embodiment will be omitted.

According to the present invention configured and shaped as described above, it is possible to compensate for a clearance even when the yoke is worn after the durability of a vehicle is lost to a certain degree. Consequently, it is possible to prevent a noise caused by an impact reversely input from an uneven road surface due to the increase of the clearance and to provide a driver with a pleasant steering feeling. In addition, since it is possible to assemble a rack bar supporting device, which includes several components, to a gear box, in a state where the components are integrally coupled to each other, it is possible to reduce difficulty in assembling and the length of time for assembling, and to prevent the loss of the components.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units.

In addition, since terms, such as “including,” “comprising,” and “having” mean that one or more corresponding components may exist unless they are specifically described to the contrary, it shall be construed that one or more other components can be included.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. A rack bar supporting device for a vehicle steering apparatus, comprising:
a support yoke configured to support a rack bar;
a support disk, the front side of which supports the support yoke, and the rear side of which is provided with a step part positioned at a diametrically outer part and formed to be axially stepped;
a yoke plug configured to be screw-coupled with a gear box, and provided with a supporting part formed to axially extend at a position corresponding to the step part; and
a torsion spring interposed between the support disk and the yoke plug.

2. A rack bar supporting device for a vehicle steering apparatus, comprising:
a support yoke configured to support a rack bar;
a support disk, the front side of which supports the support yoke, and the rear side of which is provided with a supporting part positioned at a diametrically outer part and formed to axially extend;
a yoke plug configured to be screw-coupled with a gear box, and provided with a step part formed to be axially stepped at a position corresponding to the supporting part; and
a torsion spring interposed between the support disk and the yoke plug.

3. The rack bar supporting device as claimed in any of claims 1 and 2, wherein an elastic member for providing elastic force is interposed between the support disk and the yoke plug.

4. The rack bar supporting device as claimed in claim 3, wherein the elastic member is a compression coil spring or a leaf spring.

5. The rack bar supporting device as claimed in any of claims 1 and 2, wherein a guide part is formed on the rear side of the support disk to extend from the rear side of the support disk, and a guide hole is formed in the yoke plug, such that the guide part extends through the guide hole to be supported by the guide hole.

6. The rack bar supporting device as claimed in claim 5, wherein the guide part is formed with threads on the outer circumference thereof, and a provincial assembling nut is coupled to the threads in the outside of the rear side of the yoke plug.

7. The rack bar supporting device as claimed in any of claims 1 and 2, wherein a stopper is formed at a circumferential end of the step part.

8. The rack bar supporting device as claimed in any of claims 1 and 2, wherein two or more supporting parts are provided, and the supporting parts are spaced from each other in the circumferential direction.

9. The rack bar supporting device as claimed in any of claims 1 and 2, wherein two or more step parts are formed, and the step parts are axially stepped from each other and continuously formed in the circumferential direction.

10. The rack bar supporting device as claimed in claim 9, wherein the difference in height of each of the step parts is in the range of 0.07 mm to 0.13 mm.
